(19) United States
(12) Patent Application Publication
(10) Pub. No.: US 2025/0185835 A1
(43) Pub. Date: Jun. 12, 2025

(54) Food Preparation Appliance

(71) Applicant: SEB S.A., Ecully (FR)

(72) Inventors: Romain Turpin, Ecully Cedex (FR); Philippe Dumoux, Ecully Cedex (FR)

(21) Appl. No.: 18/977,128

(22) Filed: Dec. 11, 2024

(30) Foreign Application Priority Data
Dec. 11, 2023 (FR) 2313948

(51) Int. Cl. A47J 27/08; A47J 27/086; A47J 27/09; A47J 37/06

(52) U.S. Cl. CPC A47J 27/0802; A47J 27/086; A47J 27/09; A47J 37/0641

(57) ABSTRACT

A food preparation appliance. The includes
a housing,
a container,
a main lid, and a removable sealing apparatus. The main lid can be moved between a closed position and an open position. The
removable sealing apparatus can be arranged between the housing and the main lid to allow for the first cooking mode.

The container comprises at least one container handle container arranged between the housing and the main lid, and
the main lid comprises a clearance located above the container handle.

### CROSS-REFERENCE TO RELATED APPLICATIONS

This application claims priority from French application number 2313948, filed Dec. 11, 2023, the disclosure of which is hereby incorporated herein by reference.

### TECHNICAL FIELD OF THE INVENTION

The present invention generally relates to a food preparation appliance, and more specifically to a removable inner lid of a food preparation appliance.

### STATE OF THE ART

Electric food preparation appliances featuring pressure cooking and convection cooking modes are common in the prior art. To enable pressure cooking, a removable inner lid can be added to the main lid of the food preparation appliance to seal off the cooking space in which the food is to be cooked: no air or steam can leak out of the cooking space. However, if the heating and ventilation means required for convection cooking are provided in the main lid, a hot air flow between the main lid and the cooking space is required and the inner lid must be removed. Although vents are generally provided for venting a flow of hot air and steam from convection cooking, this system may leak if there is no inner lid, particularly around the container handles, namely between the main lid and the container handles. The container handles can thus eventually reach a temperature that exposes the user handling the container during or shortly after cooking to discomfort, or even to a burn risk.

### DISCLOSURE OF THE INVENTION

One purpose of the present invention is to address the aforementioned drawbacks of the prior art and in particular, firstly, to provide a food preparation appliance that provides at least one first cooking mode comprising a step for pressure cooking food and at least one second cooking mode comprising a step for heating food by hot air flow and that does not present any risk of discomfort and/or burns during its operation and/or use.

To this end, a first aspect of the invention relates to a food preparation appliance designed to provide at least one first cooking mode comprising a step for pressure cooking food and at least one second cooking mode comprising a step for heating food by hot air flow, the food preparation appliance comprising at least:
a housing,
a compartment arranged in the housing,
a container defining a workspace for holding the food used to prepare the dish and designed to be set in the housing compartment,
a main lid, which can be moved between a closed position in which access to the workspace is prevented and an open position in which access to the workspace is permitted,
removable sealing means, designed:
   to be arranged between the housing or the container and the main lid, to allow for the first cooking mode comprising a pressure cooking step when the main lid is in its closed position, and
   to be removed from between the housing or the container and the main lid, to allow for the second cooking mode when the main lid is in its closed position, thus creating a gap between the housing and the main lid through which hot air can flow,
      in which the container comprises at least one container handle, said at least one container handle being wholly or partially arranged between the housing and the main lid when the container is set in the cooking space, characterized in that the main lid comprises a clearance located above the at least one container handle when the main lid is in its closed position. The clearance can be in the form of a free area or a cut-out, which ensures that there are no walls or obstacles above the container handles that could trap a hot air flow, at least above one end of the container handles (typically the part to be grasped or held between the fingers to handle the container). The absence of walls or of obstacles above the container handles enables a cooling convective flow to be generated by the ambient air, with the heat from said at least one handling interface being dissipated by the ambient air. The clearance thus ensures that the hot air does not flow over the container handles and escapes upwards as soon as it exits the gap between the main lid and the housing.

The food preparation appliance can also have one or more of the following features, taken alone or in combination.

According to one embodiment, the main lid and/or the food preparation appliance and/or the housing has no walls and/or obstacles and/or inner members and/or ridges and/or rims above said at least one container handle, in particular above the ends of the container handle. That is, the main lid and/or the food preparation appliance and/or the housing is designed to provide completely unobstructed access above said at least one container handle, in particular above the ends and/or the gripping part of the container handle. In other words, a vertical area above said at least one container handle, in particular above the ends and/or the gripping part of the container handle, is left free by the main lid and/or the food preparation appliance and/or the housing.

According to one embodiment, the clearance above the at least one container handle leaves an area of at least two, and preferably at least three, centimeters above the container handles (starting from their ends) free or uncovered.

According to one embodiment, the removable sealing means comprise at least one removable sealing means handle, and in the first cooking mode, said at least one removable sealing means handle is arranged in the clearance, preferably to cover said at least one container handle. A central part of the sealing means can be very hot after pressure cooking. The sealing means handles, typically located on the outside of the appliance, ensure safe handling of the sealing means with no risk of burns, particularly during cooking operations requiring a pressure cooking step and then a convection cooking step.

According to one embodiment, the housing comprises at least one housing handle arranged under said at least one container handle. Two container handles and two housing handles can be provided to enable the housing, and more generally the entire food preparation appliance, to be readily moved.

According to one embodiment, in the first cooking mode, said at least one removable sealing means handle is arranged facing said at least one housing handle. In other words, said at least one sealing means handle is positioned above the housing handles; said at least one sealing means handle is complementary in shape to the housing handles. This arrangement helps to improve the ergonomics of the appliance, since it makes it possible for the user to easily move the food preparation appliance using all the fingers of both hands, which can squeeze the handles on the housing and/or on the sealing means.

According to one embodiment, the food preparation appliance comprises a space between the container handle and the housing and/or the housing handles. In particular, the housing (or its lateral walls) can define a housing shell, and the container handles can extend beyond the housing shell or can be designed to be recessed from the housing shell or at the same level as the housing shell (in other words, flush with the housing shell). This free space enables users to slide their fingers under the container handle to grasp the container ergonomically, with no need to squeeze the container in order to lift it.

According to one embodiment, in the first cooking mode, the gap for the hot air flow is designed to be occupied and/or closed by the removable sealing means.

According to one embodiment, the removable sealing means form an inner lid designed to be removably connected or coupled to the main lid. Any type of reversible coupling can be provided (sliding or toggle hooks, 1/4 turn rotation, bayonet, screw-on coupling, etc.).

According to one embodiment, the removable sealing means comprise:
a pressure control valve, and/or
an opening/closing safety means featuring a pressure gauge system such as an Aroma pin, and/or
a safety valve, and/or
a gasket designed to fit snugly around an edge of the housing or of the container. Corresponding gaps can of course be provided in the main lid.

According to one embodiment, the main lid comprises heating means and/or cooking ventilation means arranged between the main lid and the removable sealing means when the removable sealing means are arranged between the housing or the container and the main lid to allow for the first cooking mode. The heating means and/or cooking ventilation means are arranged between the main lid and the cooking space, and more generally, the heating means and/or cooking ventilation means are arranged above the cooking space when the main lid is in the closed position.

According to one embodiment, in the first cooking mode, said at least one removable sealing means handle forms handles on the main lid when the removable sealing means are arranged between the housing or container and the main lid to allow for the first cooking mode.

### DESCRIPTION OF THE FIGURES

Other features and advantages of the present invention will become more apparent from the following detailed description of an embodiment of the invention, provided by way of non-limiting example and illustrated in the appended figures, in which:

FIG. 1 shows a food preparation appliance according to the present invention, designed to provide at least one first cooking mode comprising a step for pressure cooking food and at least one second cooking mode comprising a step for heating food by hot air flow, comprising a housing and a main lid closed on the housing, and in a configuration to provide the second cooking mode;

FIG. 2 shows a detail of handles on the food preparation appliance as shown in FIG. 1;

FIG. 3 shows the electric food preparation appliance according to the present invention with the main lid closed and in a configuration to provide the first cooking mode, namely, with a removable inner lid installed between the housing and the main lid;

FIG. 4 shows a detail of the handles on the food preparation appliance as shown in FIG. 3;

FIG. 5 shows an exploded view of the food preparation appliance, of the main lid and of the removable inner lid, with the main lid open.

### DETAILED DESCRIPTION OF EMBODIMENT(S)

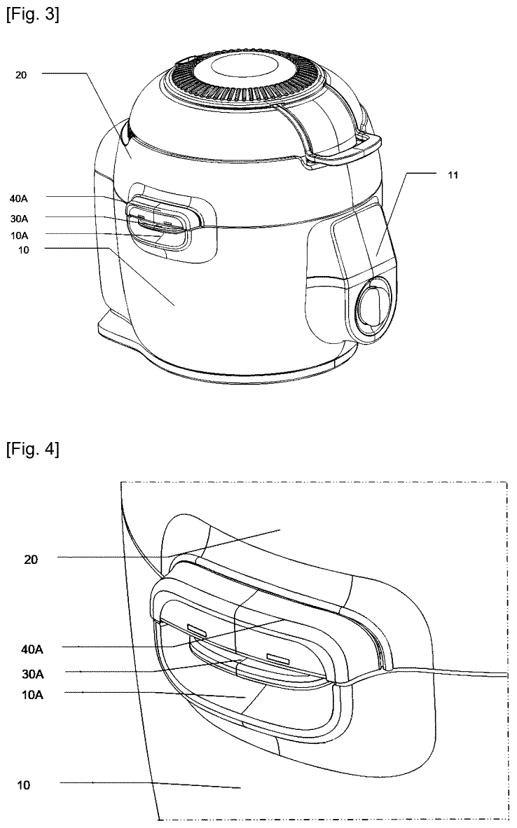

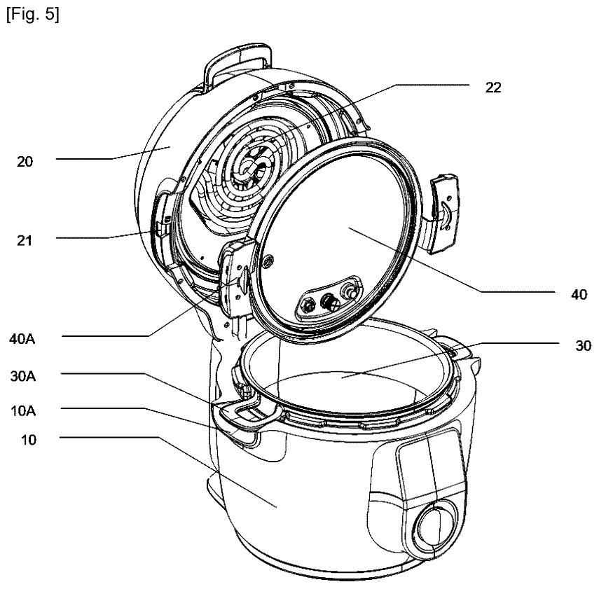

FIG. 1 shows a food preparation appliance according to the present invention, comprising a housing 10 closed by a main lid 20. An overall shell defines the outer shape of the housing 10. This relates to all of the outer walls of the housing 10, which form a substantially cylindrical shell in the example shown. The main lid 20 is hinged to the housing 10 and can open or close a compartment built into the housing 10, that can accommodate a container and/or define a cooking space. The main lid 20 can be seen in the closed position in FIGS. 1 and 3, and in the open position in FIG. 5.

The food preparation appliance is typically an electric appliance designed to operate or provide at least two cooking modes: at least one pressure cooking mode and at least one convection cooking mode. The cooking modes can be selected on a human-machine interface 11, which can be in the form of a touch screen and/or a thumbwheel and/or buttons.

The housing 10 comprises housing handles 10A so that the food preparation appliance can be easily moved. In the configuration shown in FIG. 1, the food preparation appliance thus comprises a compartment inside the housing 10 that accommodates a container 30 (seen in FIG. 5), on which a container handle 30A can be seen. The container handles 30A overhang or protrude relative to the overall shell of the housing 10; in particular, the container handles 30A are arranged on the outside of the surface containing the walls immediately adjacent to the container handles 30A, notwithstanding the housing handles 10A (also considered to protrude relative to the housing shell defined by the lateral wall of the housing 10). Thus, the container handles 30A are minimally affected by the high temperatures required in the container 30 and necessary for cooking the food. This embodiment allows for more comfortable use when gripping the container handles 30A. Alternatively, the container handles 30A could be designed to be recessed, meaning inside the housing shell 10. Alternatively, the container handles 30A could be arranged on a level similar to that of the housing shell 10.

Lastly, in the configuration shown in FIG. 1, the food preparation appliance is set up to operate in the convection cooking mode, that is, without pressurizing the cooking space.

A gap 21 can be seen above the container handle 30A and between the housing 10 and the main lid 20, which enables venting of a hot air flow typically resulting from cooking food in the container 30.

The main lid 20 is provided with a clearance above the container handles 30A, meaning that there are no obstacles or walls on the main lid 20, at the outlet, facing or above the gap 21, that can allow the hot flow circulating in the gap 21 to dissipate as it rises immediately on exiting the gap 21 into the cooler ambient air. Thus, the hot air flow does not reach the container handle 30A, located beyond the gap 21 and/or underneath the gap 21.

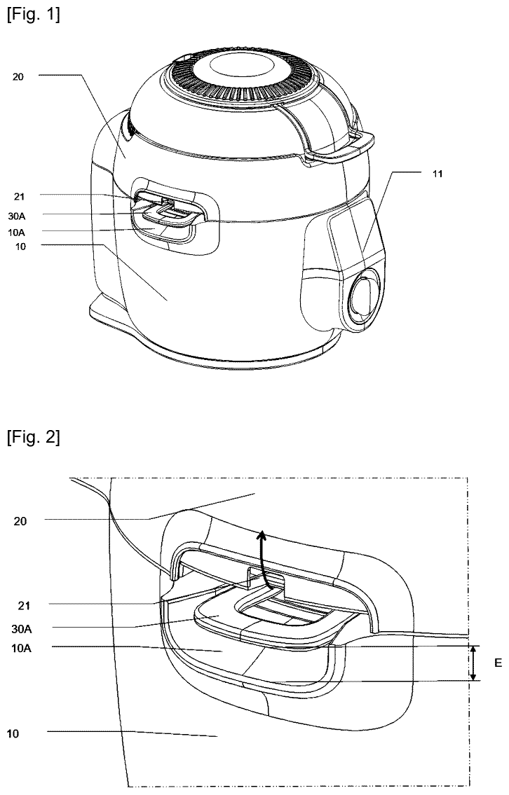

FIG. 2 shows a detailed view of the handles on the food preparation appliance in FIG. 1. The container 30 is designed such that there is a gap E between the container handle 30A and the housing handle 10A, large enough to allow a user's fingers to fit under the container handle 30A in order to remove the container 30 from the housing 10.

It should be noted that, due to the clearance of the main lid 20, the ends of the container handles 30A are not covered or hidden by any wall or rim of the main lid 20. In particular, at least the last two or three centimeters of the container handles 30A can be considered to be left completely uncovered by the main lid 20, so that hot air escaping from the gap 21 can rise into the ambient atmosphere without touching or heating the container handles 30A.

FIG. 3 shows the food preparation appliance in FIG. 1 configured to operate in pressure cooking mode.

To this end, the food preparation appliance is equipped with removable sealing means in the form of a removable inner lid 40 (seen in FIG. 5), on which the presence of removable sealing means handles 40A above the container handles 30A can be seen in FIG. 3.

The removable inner lid 40 can be coupled into the main lid 20 to seal off the cooking space in the food preparation appliance and allow for pressure cooking in the container 30. The coupling between the removable inner lid 40 and the main lid 20 is designed to be reversible to enable quick and easy configuration.

To this end, the removable inner lid 40 and the main lid have complementary locking means arranged outside the cooking space between the cooking space and the clearance arranged on the main lid. The presence of the clearance leads to a significant reduction in the space required to accommodate the complementary locking means.

The clearance, made unnecessary by the cooking space sealing provided by the removable inner lid 40, is occupied by the removable sealing means handles 40A, allowing for easier handling of the housing by forming additional housing handles, and also allowing for handling of the removable inner lid 40. Once the removable inner lid 40 has been removed, the clearance is freed up again to allow for more effective venting of hot air that may transit between the main lid 20 and the cooking space, thus limiting the temperature build-up of the container handles 30A.

It should be noted that the gap 21, also made unnecessary by the cooking space sealing provided by the removable inner lid 40, is occupied by the removable inner lid 40 and its connection to the removable sealing means handles 40A.

FIG. 5 shows the food preparation appliance with the main lid 20 in an open position. The removable inner lid 40 is detached (that is, it is being assembled or disassembled) to clearly show the inner structure.

Regarding the removable inner lid 40 and its assembly on the main lid, it should be noted in this instance that sliding triggers are provided on the removable sealing means handles 40A to control coupling hooks. However, any other type of reversible coupling can be provided (¼ turn, bayonet, screw-on, etc.).

As can be seen from the position of the removable inner lid 40 shown in FIG. 5, the main lid 20 has built-in heating means 22 arranged facing the cooking container 30, so that convection is generated with the food to be cooked (typically a heating coil and cooking ventilation means can be provided).

The removable inner lid 40 itself comprises safety and operating components to allow for pressure cooking: a pressure control valve, an opening/closing safety means featuring a pressure gauge system such as an Aroma pin, a safety valve, and a gasket designed to fit snugly around an edge of the housing 10.

The main lid 20 can be folded back onto the housing 10 for cooking.

When the removable inner lid 40 is coupled (FIGS. 3, 4), pressure cooking is possible and no hot air flows through the gap 21, as the cooking space is leakproofed by the removable inner lid 40, which itself occupies the gap 21.

When the removable inner lid 40 is removed (FIGS. 1, 2), convection cooking is possible, and any hot gases (typically cooking vapors) can escape through the gap 21 without heating the container handles 30A, due to the clearance on the main lid which keeps these hot gases from heating the container handles 30A. The clearance also enables the ambient air itself to cool the container handles 30A, which could be heated by heat conduction from the container body 30.

### INDUSTRIAL APPLICATION

A food preparation appliance according to the present invention, and the manufacture thereof, are suitable for industrial application.

It will be understood that various modifications and/or improvements that are obvious for the person skilled in the art may be made to the different embodiments of the invention described in this description without departing from the scope of the invention. In particular, it should be noted that the gap 21 for a hot air flow and the clearance could be located elsewhere around the edge of the main lid 20.

1. A food preparation appliance comprising:
a housing,
a compartment disposed in the housing,
a container defining a workspace configured for holding food used to prepare a dish and to be set in the housing compartment,
a main lid configured to move between a closed position in which access to the workspace is prevented and an open position in which access to the workspace is permitted, and
a removable sealing apparatus, configured:
to be disposed between the main lid and the housing or the container to allow for a first cooking mode when the main lid is in the closed position, and
to be removed from between the main lid and the housing or the container to allow for a second cooking mode when the main lid is in the closed position, thus creating a gap between the housing and the main lid through which hot air can flow,
wherein the container comprises a container handle container that is wholly or partially arranged between the housing and the main lid when the container is set in the cooking space, and
wherein the main lid comprises a clearance located above the container handle when the main lid is in the closed position.

2. The food preparation appliance according to claim 1, wherein the removable sealing apparatus comprises a removable sealing handle,
and wherein, when in the first cooking mode, the removable sealing handle is arranged in the clearance container.

3. The food preparation appliance according to claim 2, wherein the housing comprises a housing handle disposed below the container handle.

4. The food preparation appliance according to claim 3, wherein, when in the first cooking mode, the removable sealing handle faces the housing handle.

5. The food preparation appliance according to claim 3, further comprising a gap between the container handle and the housing and/or the housing handle.

6. The food preparation appliance according to claim 1, wherein, when in the first cooking mode, the gap for the hot air flow is configured to be occupied and/or closed by the removable sealing apparatus.

7. The food preparation appliance according to claim 1, wherein the removable sealing apparatus is an inner lid configured to be removably connected to the main lid.

8. The food preparation appliance according to claim 1, wherein the removable sealing apparatus comprises:
a pressure control valve, and/or
an opening/closing safety indicator including a pressure gauge system, and/or
a safety valve, and/or
a gasket configured to fit snugly around an edge of the housing or an edge of the container.

9. The food preparation appliance according to claim 1, wherein the main lid comprises a heating element and/or a cooking ventilation mechanism disposed between the main lid and the removable sealing apparatus when the removable sealing apparatus is arranged between the main lid and the housing or the container to allow for the first cooking mode.

10. The food preparation appliance according to claim 2, wherein the removable sealing handle includes a pair of handles configured to abut the main lid when the removable sealing apparatus is disposed between the main lid and the housing or the container to allow for the first cooking mode.
